(19) United States
(12) Patent Application Publication
(10) Pub. No.: US 2008/0128227 A1
(43) Pub. Date: Jun. 5, 2008

(54) Wheelchair Safety Brake Assembly

(76) Inventor: Arthur F. Yeager, Silver Spring, MD (US)

Correspondence Address: OFFICE OF THE STAFF JUDGE ADVOCATE;U.S. ARMY MEDICAL RESEARCH AND MATERIEL COMMAND, ATTN: MCMR-JA (MS. ELIZABETH ARWINE), 504 SCOTT STREET, FORT DETRICK, MD, 21702-5012, US

(21) Appl. No.: 11/929,184

(22) Filed: Oct. 30, 2007

Related U.S. Application Data
(63) Continuation-in-part of application No. 11/167,931, filed on Jun. 28, 2005, now Pat. No. 7,316,298.
Application No. 11/167,931 is a continuation-in-part of application No. 10/425,034, filed on Apr. 29, 2003, now abandoned.
(60) Provisional application No. 60/375,815, filed on Apr. 29, 2002.

(51) Int. Cl. B62B 5/04

(52) U.S. Cl. 188/2 F

(57) ABSTRACT

This invention relates to gravity reactive braking systems. According to the invention there is provided a brake system to control speed in a forward direction for descending inclined surfaces and a brake system for controlling rollback when ascending an inclined surface. The speed pacer braking assembly includes a downhill activator for selectively engaging a disc brake system when a predetermined inclined is reach. The anti-rollback assembly comprises a pair of graded brake cam structures operatively disposed adjacent wheels wherein the natural pull of gravity and the configuration of the cams operate to allow passage of wheels in both directions when on flat surfaces and in only a single direction when on an incline. When on an incline, gravity operates to dispose cams relative to the wheels such that rotation of wheels in one direction is hindered by a thickening of cam body caused by rotation of cam about its axis. Both systems include adjustment means for setting the incline angle at which brake assemblies will operate to hinder wheel rotation in the undesired direction.

This application is a continuation-in-part of co-pending U.S. application Ser. No. 11/167,931, filed Jun. 28, 2005, which is a continuation-in-part of now abandoned U.S. application Ser. No. 10/425,034, filed Apr. 29, 2003, which is a nonprovisional of U.S. Provisional Application 60/375,815, filed Apr. 29, 2002. Each of these patent applications is hereby incorporated by reference.

### I. FIELD OF THE INVENTION

The present invention relates to braking systems. More particularly, the present invention relates to a gravity reacting anti-rollback braking system for wheel chairs on inclined surfaces.

### II. BACKGROUND OF THE INVENTION

The invention of the wheel greatly revolutionized the transportation of persons and materials. As will be appreciated, wheels must have brakes or a means to cease the rotation of the wheel to stop the movement of the vehicle to which they are attached. With vehicles powered manually, such as strollers, carts, stretchers, and the like, the provision of braking mechanisms poses unique challenges. As will be appreciated, without a braking mechanism, these vehicles cannot be left unattended on slopes or non-flat surfaces in view of the fact that the force of gravity will induce the wheels (and thus the vehicle) to roll in the descending direction. This problem is a particular concern with manually or arm-powered devices, such as wheelchairs, for example, where the safety of an occupant is of utmost importance.

As will be appreciated, caregivers attending to a wheelchair occupant sometimes need to leave the occupant unattended to, for example, open a door or prepare a car lift. In these periods, the occupant may need to prevent the wheelchair from descending an incline, or from undergoing what is know in the art as a “rollback.” Some occupants do not have the stamina, strength, or mental faculties to prevent a rollback on inclines.

In an effort to prevent rollbacks, some prior artisans crafted wheelchairs with wheel locks for locking the large, rear wheels against rotation. With these prior art devices, a wheel lock assembly is typically mounted to the frame of the wheelchair adjacent each rear wheel. Each wheel lock assembly includes a hand-operated lever which is connected by mechanical means to a braking member for engaging the tire tread at the periphery of the wheel. Accordingly, when the lever is disposed in a free wheeling position, the braking member is spaced away from the wheel and the tire so as to allow the wheel to rotate freely. Likewise, when the handle is moved to the locked position, the brake member is moved into contact with the tire with sufficient force so as to press into, and temporarily deform, the outer surface of the tire to frictionally hinder rotation of the tire.

One of the drawbacks with these prior art rear wheel locks is that they require either a large manual effort or a long throw to lock the wheels from further rotation. Another drawback of these prior art devices is that the braking mechanism prevents any rotation of the tires in either direction. As will be appreciated, it is desirable at times to allow the wheels to move in the ascending direction while inhibiting movement in the descending direction, such as with a patient being transported or ascending an incline. For example, if the operator were to stop propelling the wheelchair up a hill and relax, gravity would urge the chair to roll backwards. Similarly, if the occupant removed his hands from the wheels to push open a door, the pushing tends to force the wheelchair in the opposite direction. This is true even with automatic doors, wherein the occupant is forced to press against a button to actuate the door. Oftentimes, an occupant must engage the brake to prevent a rollback when pressing the open button for a door; and unfortunately, by the time the occupant disengages the brake to egress through the door, the door would close again.

Accordingly, it is desirable to provide a one-way braking mechanism to provide for rotation of the wheels in only the forward direction. In an effort to meet this need, some prior artisans crafted “hill holder” mechanisms, or one-way clutches, to attach to the hub of the rear wheels. These prior art clutches are relatively expensive and mechanically complex. Other hill holders have been devised which also incorporate a wheel lock assembly. However, these combination devices suffer from numerous drawbacks as well. For example, U.S. Pat. No. 4,887,830 to Frough et al discloses a wheelchair with a combined wheel lock and hill holder. The device uses a cam to engage the brake. However, the device is spring loaded and must thus be manually engaged and disengaged. Once engaged, the wheelchair is hindered from movement in the rearward direction completely. Furthermore, once engaged, the drag of the device on a user's forward motion remains a noted drawback.

More significantly, with these prior art wheelchairs, the braking device needs to be disengaged anytime the wheels are to be rolled in the rearward direction. The constant burden of manually engaging and disengaging a device depending on whether the occupant is on level ground or desires to move rearwardly is a significant drawback to such devices. As will be appreciated, for wheelchair occupants of limited cognitive ability, upper body strength, dexterity, range of motion, coordination, or the like, manually engaging and disengaging a safety device is not a viable option.

One particularly advantageous braking system for overcoming the problems and drawbacks associated with prior art rollback prevention systems was described by the present inventor in U.S. Ser. No. 10/425,034, filed Apr. 29, 2003, entitled “Gravity Reacting Anti-Rollback Brake,” the contents of which are hereby incorporated by reference in their entirety. As set forth in the application, a preferred embodiment of the Gravity Reacting Anti-Rollback Brake system, or “GRAB” system, comprises a pair of graded brake cam structures disposed on opposite ends of a connecting rod. The connecting rod and cams are operatively disposed adjacent the back wheels of a wheelchair via a lever assembly mount. The natural pull of gravity and the configuration of the cams operate to allow passage of wheels in both directions when on flat surfaces and in only a single direction when on an incline. Specifically, when on an incline, gravity operates to dispose cams relative to the wheels such that rotation of the wheels in one direction is hindered by a thickening of the cam body caused by rotation of the cam about its axis. The system also includes an adjustment mechanism for setting the incline angle at which the cams will operate to stop wheel rotation in the undesired direction.

The GRAB system poses a novel and advantageous apparatus for dealing with the problem of rollback with wheelchair devices and the like and is the focus of the present application.

It will also be appreciated that there are times when it would be advantageous for controlling the speed and movement of a wheelchair or other wheeled craft or device when descending an incline in the forward direction. To exemplify the long-felt need in the art, consider electric wheelchairs for instance. Electric wheelchairs not only provide users with powered movement, but also provide automatic braking. Thus, electric wheelchairs inherently prevent unwanted rollback and govern forward speed on inclines or slopes regardless of the weight, strength or endurance of the user. By contrast, manually powered wheelchairs do not. Manually powered wheelchairs require a constant force grip that is affected by the weight, strength and endurance of the operator. Not all wheelchair users need the assistance of an electric wheelchair because these individuals have sufficient strength and dexterity to propel and navigate themselves. However, all wheelchair users can benefit from automatic assisted braking when descending a steep hill. Accordingly, without a braking system, manual wheelchair users attempting to navigate a hilly or steep terrain are at a disadvantage to an electric wheelchair user. Thus, paradoxically, users not requiring the assistance of an electric wheelchair find their community mobility more compromised than those in need of an electric wheelchair.

Applicant's co-pending U.S. application Ser. No. 11/167,931, filed Jun. 28, 2005, now allowed, the contents of which are hereby incorporated by reference in their entirety, disclosed and claimed a braking system making use of a forward movement braking system and also a hybrid braking system using both a forward movement braking system and an anti-rollback brake. The present application is particularly focused on the anti-rollback aspect of the invention.

### III. BRIEF DESCRIPTION OF THE DRAWINGS

The present invention is described with reference to the accompanying drawings. In the drawings, like reference numbers indicate identical or functionally similar elements.

FIG. 1 is a plan view of a graded brake cam assembly according to the present invention.

FIG. 2 is a partial plan view of a wheelchair gravity reactive anti-rollback brake according to the invention.

FIG. 3 is a partial side view of a wheelchair gravity reactive anti-rollback brake according to the invention.

FIGS. 4A-C depict a lever release mechanism according to the invention.

FIG. 5A is a perspective view in isolation of an embodiment of a gravity reacting anti-rollback brake on flat terrain according to the invention.

FIG. 5B is a perspective view in isolation of an embodiment of a gravity reacting anti-rollback brake when ascending inclined terrain according to the invention

FIG. 6A is a side view of a portion of an embodiment of a brake assembly according to the invention on flat terrain.

FIG. 6B is a side view of a portion of an embodiment of a brake assembly according to the invention on a downhill slope.

FIG. 6C is a side view of a portion of an embodiment of a brake assembly according to the invention on an uphill slope

FIG. 7 is a side view of a portion of an embodiment of a brake assembly including variable sensitivity adjusters for adjusting the incline/decline angle at which the brake will engage.

FIG. 8 depicts a control panel, tilt switch, and solenoid assembly for use in an alternative embodiment of the invention for adjusting the braking force of a brake assembly.

### IV. DETAILED DESCRIPTION OF THE DRAWINGS

The present invention is based, in part, on the concept that a gravity reacting braking system can prevent undesired movement of objects disposed on an incline. While the present invention will be described in connection with a wheelchair, it will be readily apparent to one of ordinary skill in the art that the present invention can be applied to a multiplicity of fields and uses. In particular, the present invention may find use for preventing the movement of other manually powered vehicles such as carts, stretchers, strollers and the like.

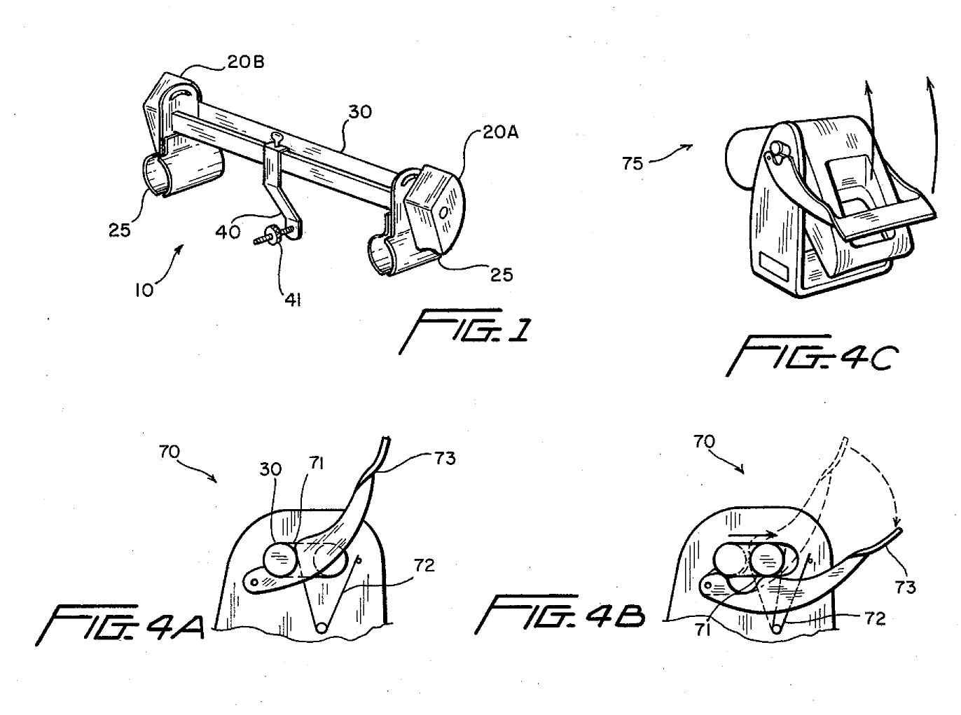

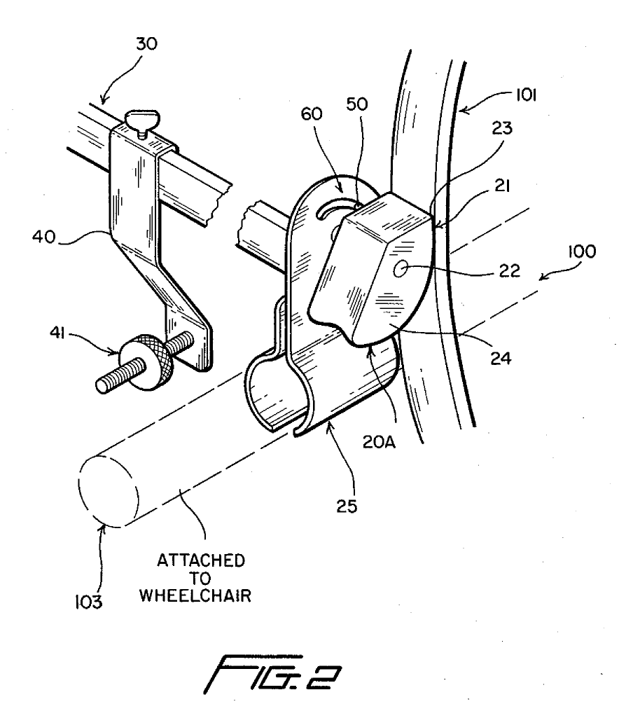

FIGS. 1-4 depict a preferred embodiment of the invention. In this embodiment, gravity reacting anti-rollback brake system 10 may be coupled to wheelchair 100. The invention contemplates that the simple construction and configuration of brake system 10 is such that the device may be adapted to retrofit almost any existing wheelchair. The brake system is preferably attached to the frame of the chair in an area just forward of the larger wheel.

According to the presently preferred embodiment, brake system 10 preferably utilizes a pair of graded brake cams 20A, 20B, one for each rear wheel 101 of chair 100. Although this embodiment features brake cams operatively positioned to engage the outer surface of the tire of the wheels, any alternative positioning which allows the cams to hinder rotation of a body, axle, or the like is understood to be within the scope of the invention. Graded brake cams 20A, 20B are graded such that their gripping power is increased as the face 21 of the cam is engaged. Any suitable configuration of brake cams is understood to be within the scope of the invention. For example, it is well within the skill of the ordinary artisan to adapt a configuration which allows for free movement of the wheels in both directions when on flat terrain and prevents movement in one direction when a predetermined incline is reached.

Graded brake cams 20A, 20B are preferably disposed on opposite ends of connecting rod 30. Preferably, connecting rod 30 extends through and serves as the fulcrum for each brake cam. Further, according to this embodiment of the invention, connecting rod 30 and brake cams 20A, 20B are configured to allow the weight of rod 30 to be such that gravity keeps the cams operatively positioned. One of ordinary skill in the art will appreciate this as the principal behind so-called “broom holders” that use the weight (force) of the broom to keep the holder engaged.

Preferably, connecting rod 30 also serves to insure simultaneous engagement of both rear wheels 101, 102. Simultaneous and uniform engagement is preferable to prevent lateral movement, misalignment, or spinning of the wheelchair.

Presently preferred brake cams comprise a durable material, such as lightweight and strong metal alloy(s). According to the invention, brake pads can be used with brake cams to accommodate a range of wheels and environments. Alternatively, to prevent wear, it is possible to construct brake cams from a strong unitary material, such as metal, and provide the outer cam surface with serrations or teeth for grip. Likewise, brake pads may comprise any suitable material. If used, brake pads are preferably interchangeable and thus may be easily replaced when worn.

To attach brake system to the wheelchair, a lever assembly mount 25 is provided. The assembly mount 25 preferably couples to the wheelchair to provide rigid support for the brake system. The assembly mount preferably is used to secure the brake device to the lower frame 103 of the chair in an area just forward of the larger wheel 101. The lever assembly 25 in this embodiment is of a clamp design to allow fore and aft adjustment. Adjustment is desirable when two brake cams are used to help ensure simultaneous engagement of the cams with the wheels. The lever assembly 25 may be mechanically mounted to chair via a nut and bolt, or any other suitable means. Any assembly which allows for secure connection to a vehicle while allowing gravitational disposition of the cam(s) is understood to be within the scope of the invention. Preferably, the assembly will also provide for simultaneous engagement if a plurality of cams are used.

Disposed between brake cams 20A, 20B on connecting rod 30 is adjustment mechanism or adjuster 40. The adjuster 40 preferably comprises an adjustable weight 41 which may be positioned to influence the slope at which the cams will contact the tires. The adjuster 40 according to this embodiment of the invention has a weight which can be adjusted to cause cams to engage at a specified slope angle or desired sensitivity.

As will be appreciated, gravity keeps the weight at a constant 180 degrees from the brake cam fulcrum 22 regardless of the angle of the wheelchair. The cams are configured such that on level surfaces, the cam is not in contact with the wheel thereby allowing freewheeling in a forward and rearward direction. However, the changing of the angle of the wheelchair frame (i.e., via an incline) in relation to the constant, gravity-induced brake-cam position results in a diminishing clearance between the braking surface of cam surface and the rear wheel. Since the grade of the cam lessens 23 in favor of the intended direction of movement, the cam does not impede movement of the rear wheel. However, the grade of the cam increases 24 in the opposite direction. The cam's movement towards the wheel periphery directly correlates to the wheelchair's rotation around the hub of the main wheels. Once in contact with the wheel, any rearward rotation leads to an increasing grip by the cam as it thickens when rotated about its axle 22. Accordingly, the cam serves to prevent further rotation of the wheels in that direction.

Extending from the brake cam is short rod 50 that moves through slotted arc 60 in lever assembly mount 30. The arc provides the travel limits of the brake cam's rotation and ultimately the stopping force from the immobile wheelchair frame.

In the present embodiment, brake 10 is configured and disposed to prevent rearward movement of wheelchair 100 when wheelchair 100 is on an incline. According to this embodiment, depending on the user's needs and abilities, the brake 10 can be configured to engage at a specific incline. By contrast, according to another preferred embodiment, and as will be appreciated by one of ordinary skill in the art, the brake system can be configured and disposed on a wheelchair to allow the user to move rearwardly and not forwardly when on an incline (for users who prefer or need to move up inclines backwards). It is well within the ability of one of ordinary skill in the art armed with the present specification to modify the shape, configuration or disposition of the system to achieve the intended purpose.

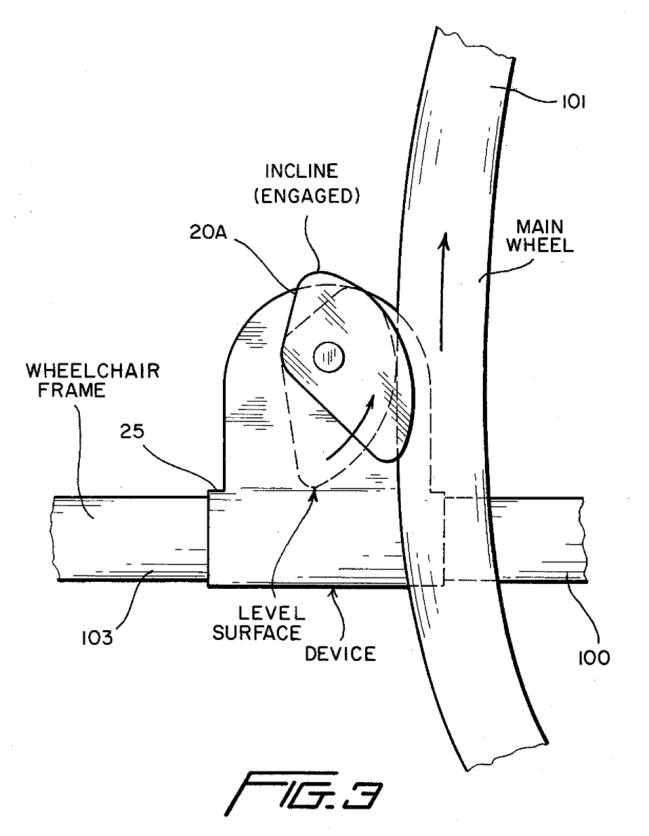

According to the present invention, the brake system 10 may include a release mechanism 70 for releasing the rollback protection when needed, for example, when having to move back from an outwardly opening automatic door. A presently preferred embodiment is depicted in FIGS. 4A-C. As shown, the connecting rod 30 or an axle 22 of cam is disposed in a slit 71 and spring biased by spring 72 to keep the brake cams operationally positioned relative to their respective wheels. The rod 30 is connected to lever 73 which allows the operator to actuate the lever and overcome the spring bias to move the rod across the slit and carry the brake cams a distance from their respective wheels to ensure the cams do not engage the wheels and restrict movement. This type of release mechanism may be suited for use with any type of vehicle and positioned in the back of a wheelchair or on the handle of a stroller if desired. For example, a cable could be attached to the spring release to provide for actuation from an area away from the connecting rod or axle with, for example, the lever assembly 75 of FIG. 4C. However, it is well within the ability of one of ordinary skill in the art to provide a mechanism which moves the cam brakes out of operational position with their respective wheels.

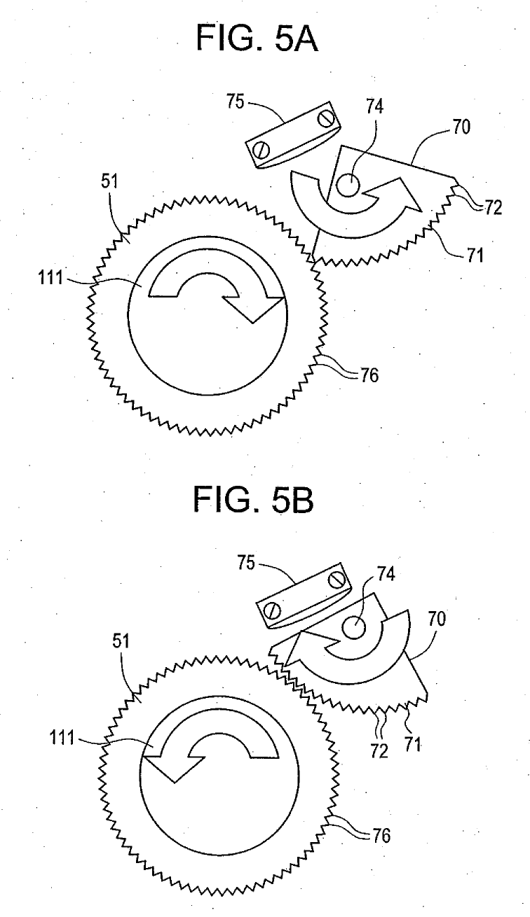

The GRAB assembly of FIGS. 5-8 associates the graded brake cams with the respective axles of the wheel instead of the hub of the wheel as done in the embodiment set forth in FIGS. 1-4. This newly preferred configuration is presently believed to provide three advantages; namely, ease of configuring the chair to be folded for storage or transportation; reducing potential decreased performance due to dirt or water on the wheel; and ease of coupling the system with the GRASP system for a combined brake system. However, this new configuration is not mandatory. Additional details of this system may be found in Applicant's co-pending U.S. application Ser. No. 11/167,931, filed Jun. 28, 2005, which is hereby incorporated by reference.

As depicted in FIGS. 5A and 5B, brake cams 170 are graded such that their gripping power is increased as the face 171 of the cam is engaged. Any suitable configuration of brake cams is understood to be within the scope of the invention. For example, it is well within the skill of the ordinary artisan armed with the present specification to adapt a configuration which allows for free movement of the wheels in both directions when on flat terrain and prevents movement in one direction when a predetermined incline is reached.

Presently preferred brake cams comprise a durable material, such as lightweight and strong metal alloy(s). According to the invention, brake pads can be used with brake cams to accommodate a range of wheels and environments. Alternatively, to prevent wear, it is possible to construct brake cams 170 from a strong unitary material, such as metal, and provide the outer cam surface 171 with serrations or teeth 172 for grip (or for interlocking with cooperating teeth or serrations disposed on the axle in a preferred embodiment). Likewise, brake pads may comprise any suitable material. If used, brake pads are preferably interchangeable and thus may be easily replaced when worn.

As shown in FIG. 5A, the cams 170 are configured such that on level surfaces the cam face 171 is not in contact with the wheel or, in this embodiment, the teeth of inner ring 151 of wheel axle 111, thereby allowing freewheeling in a forward and rearward direction. However, as shown in FIG. 5B, the changing of the angle of the wheelchair frame (i.e., via an incline) in relation to the constant, gravity-induced brake-cam position results in a diminishing clearance between the braking surface of cam surface and the axle of the rear wheel. Since the grade of the cam lessens in favor of the intended direction of movement, the cam does not impede movement of the rear wheel in a forward direction. However, the grade of the cam increases in the opposite direction. The cam's movement towards the wheel periphery directly correlates to the wheelchair's rotation around the hub of the main wheels. Once in contact with the wheel, any rearward rotation leads to an increasing grip by the cam as it thickens when rotated about its fulcrum 174. Thus, the cam serves to prevent further rotation of the wheels in that direction. Preferably, a stop 175 is provided to block the cam from over rotation or breaking due to the large stress and weight that may be encountered in operation.

As alluded to above, according to a presently preferred embodiment, the axle or inner ring 151 connected to the axle is provided with teeth 176 or the like for mating with reciprocal interlocking teeth on the cam head. Accordingly, the teeth interlock as the axle rotates to cause stoppage of the rotation in a rearward direction when on incline terrain. Furthermore, stop 175 acts as the final reinforcement to cam to stop any further movement in the rearward direction.

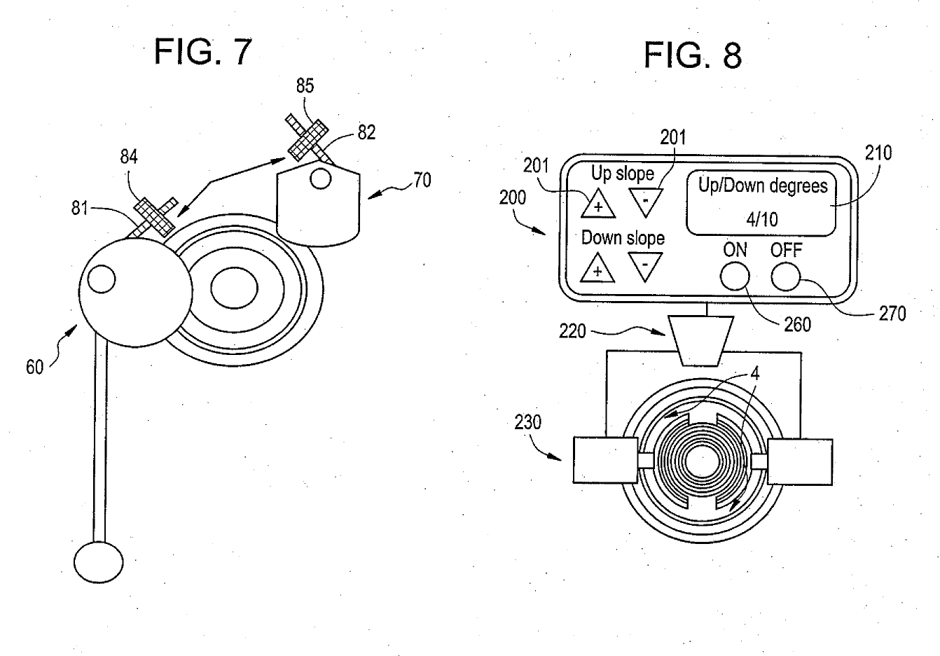

Operatively disposed in connection with brake cams 170 is adjustment mechanism or adjuster 180 (see FIG. 7). As will be appreciated, gravity keeps the weight at a constant 180 degrees from the brake cam fulcrum 174 regardless of the angle of the wheelchair. The adjuster 180 preferably comprises an adjustable weight 181 which may be positioned to influence the slope at which the cams will contact the axles. The adjuster 180 according to this embodiment of the invention has a weight which can be adjusted to cause cams to engage at a specified slope angle or desired sensitivity.

Also according to the invention, the brake system may include a release mechanism for releasing the rollback protection when needed, for example, when having to move back from an outwardly opening automatic door. It is well within the ability of one of ordinary skill in the art to provide a mechanism which moves the cam brakes out of operational position with their respective wheels.

Likewise, it is well within the ability of one of ordinary skill in the art armed with the present specification and Applicant's previously identified co-pending application to modify the shape, configuration or disposition of the GRAB system and/or its components to achieve the intended purpose.

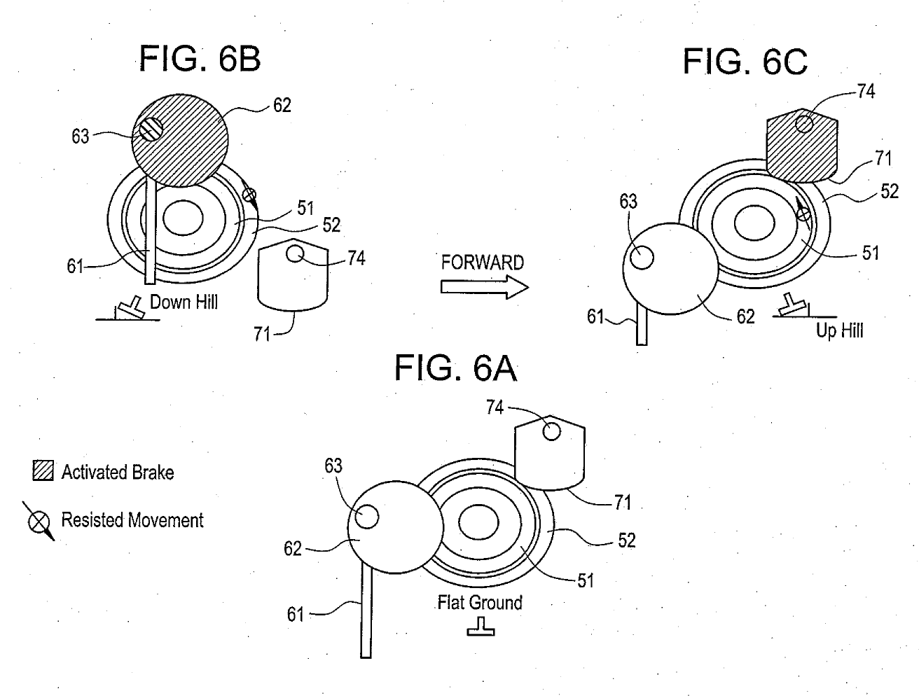

FIGS. 6A-C depict a presently preferred embodiment of a brake system which utilizes both a GRASP assembly and a GRAB assembly. Once again, the face 171 of cammed head 170 of the GRAB assembly is preferably configured to comprise teeth or the like (see FIGS. 5A and 5B) that allows the cammed head 171 to interlock with the threads or teeth of the inner ring 151 of the safety bearing 150 of the GRASP assembly. Accordingly, as depicted in FIG. 6A, when on flat ground, both the down-hill activator 160 of the GRASP assembly and the cammed head 170 of the GRAB assembly are gravitationally disposed to allow the inner ring 151 of the safety bearing 150 to reside outside of the outer ring 152. This configuration thus allows the axle in bearing housing to rotate freely in the forward and rearward directions.

However, as depicted in FIG. 6B, once downhill terrain of a sufficient or predetermined grade is encountered, gravity acts as previously described herein to allow the down-hill activator 160 to engage inner ring 151 of the safety bearing 150 and overcome the spring bias to force the inner ring 151 towards the inside and into an interlocked position with the outer ring 152. The outer ring 152 in turn is connected to a respective disc brake. Thus, as the system operates to provide the calipers force to squeeze the disc brake(s), a resultant slowing or stoppage of the outer ring occurs, which in turn provides for a corresponding slowing or stoppage of the rotation of the wheel axle and wheels in the forward direction. Accordingly, use of the system allows for controlled or stopped movement when descending an inclined surface in the forward direction.

By contrast, as depicted in FIG. 6C, when up hill terrain is encountered, if the angle of inclination exceeds the predetermined setting of the GRAB assembly, the face of cammed head 171 mates the axle bearing through interlocking teeth or the like to prevent rearward movement of the wheel as previously described herein.

FIG. 7 depicts a portion of a combination brake having both a GRASP assembly and a GRAB assembly to better illustrate the use of variable sensitivity adjusters according to this aspect of the invention. Variable sensitivity adjusters are preferably provided to allow for the angle of incline/decline at which the respective gravity reactive brake assemblies will engage to be predetermined and adjusted. In this illustrative embodiment, the variable sensitivity adjusters comprise a threaded body 181, 182, such as a bolt, and weights 184, 185, such as nuts, which may be threaded to mate with the threads of the bolt. As will be appreciated, by manipulating the position of counterweights, the angle of incline/decline at which the weight of the activators causes the brakes to engage can be controlled. One of ordinary skill in the art armed with the present specification can devise numerous alternate configurations of counterweights or adjustment mechanisms which affect the angle of incline at which the brake(s) will engage.

FIG. 8 depicts an alternative embodiment of a brake system for use in the present invention. Rather than using mechanical weights and gravity to control the angle at which the brakes will be activated, this embodiment uses a tilt switch (or other device capable of sensing sloped terrain) and solenoid assembly that controls the speed of rotation of a wheeled vessel or manipulates the gears of a brake assembly of the types described above. Although any suitable electrical assembly may be used, in a preferred embodiment there is provided a battery powered tilt switch 220 and a two-solenoid braking assembly 230. In this embodiment, one solenoid locks to prevent rollback on an up slope and the other locks the turning axle on the downhill with the disc braking system. It is also suitable to use a solenoid assembly for one or the other braking systems but maintain use of a mechanical adjuster 181 or 182 for the other.

In the embodiment of FIG. 8, a control panel 200 in communication with a tilt switch 220 is provided. The control panel 200 includes buttons 201 that a user can use to increase or decrease the angle of incline/decline at which the switch 220 will actuate for either controlling gears and/or locking the axle to hinder or prevent movement in an unwanted direction on terrain having a slope equal or greater to the manually (or preset) slope.

The control panel can also include a display 250 to provide the user with information relating to the brake settings. In addition to the settings, the display 250 can include other information that may be of interest to a user of the device. The system can also include an “on” switch 260 and an “off” switch 270 (or a toggle switch that provides both functions). The on/off switching ability could allow a user to turn of the system when automatic braking is not desired or necessary. Numerous permutations of functions can be included in connection with the control or artificial intelligence built into the controller. For example, the control panel can be provided with memory that allows predetermined settings to be saved and stored for use at a later. The explication of every feature that could be included in the operation of an electrical or intelligent switching system are beyond the scope of the present invention. Suffice it to say that one of ordinary skill in the art armed with the present specification can use other types of reliable switches to eliminate the pendulum type activation previously described and/or allow a user to adjust the sensitivity of the braking systems selectively.

Those skilled in the art will appreciate that various adaptations and modifications of the above-described preferred embodiments can be configured without departing from the scope and spirit of the invention. Therefore, it is to be understood that, within the scope of the appended claims, the invention may be practiced other than as specifically described herein.

We claim:

1. A brake system comprising:
a brake cam gravitationally disposed adjacent a rotatable body;
said brake cam being gravitationally disposed in a first position when said rotatable body is on a level surface, wherein there is a distance between said brake cam and said rotatable body, thereby allowing said rotatable body to rotate in a forward and backward direction;
said distance being affected by the orientation of said rotable body such that said brake cam contacts said rotatable body when said rotatable body reaches a predetermined incline;
said brake cam being graded to allow rotation of said rotatable body in one direction and not the opposite direction when said brake cam is in contact with said rotatable body.

2. The brake system of claim 1, further comprising an adjuster for setting said predetermined incline.

3. The brake system of claim 2, wherein said adjuster comprises an adjustable weight.

4. The brake system of claim 1, wherein said rotatable body is a wheel.

5. The brake system of claim 4, wherein said cam includes teeth for interlocking with teeth associated with an axle of said wheel.

6. The brake system of claim 5, further comprising a second rotatable body having a brake cam gravitationally disposed adjacent said second rotatable body, and wherein said rotating bodies are rear wheels of a wheelchair.

7. The brake system of claim 6, further comprising means for disengaging said cams from contact with said wheels after reaching or exceeding said predetermined angle.

8. The brake system of claim 1, further comprising a release mechanism for disengaging said brake cam from said rotatable body to allow rotation of said rotatable body in both directions.
